(19) United States
(12) Patent Application Publication
(10) Pub. No.: US 2023/0099051 A1
(43) Pub. Date: Mar. 30, 2023

(54) ARRAY-TYPE SENSOR CHIP AND DATA OUTPUT METHOD THEREFOR

(71) Applicant: NINGBO ABAX SENSING CO., LTD., Ningbo City, Zhejiang (CN)

(72) Inventor: Shuyu LEI, Ningbo City, Zhejiang Province (CN)

(73) Assignee: Ningbo ABAX Sensing Electronic Technology Co., Ltd., Ningbo City (CN)

(21) Appl. No.: 17/908,091

(22) PCT Filed: Dec. 17, 2020
(86) PCT No.: PCT/CN2020/137319

§ 371 Date: Aug. 30, 2022

(30) Foreign Application Priority Data
Mar. 6, 2020 (CN) 202010155814.8
May 9, 2020 (CN) 202010385945.5

(51) Int. Cl. G01D 5/12; G06F 3/06

(52) U.S. Cl. CPC G01D 5/12; G06F 3/06

(57) ABSTRACT

A data processing method and an array-type sensor, which relate to the technical field of semiconductors. The array-type sensor comprises a processing unit (120) and a plurality of sensing units (110), and the plurality of sensing units (110) are separately connected to the processing unit (120); the sensing units (110) are configured to receive external signals, convert the external signals into unit values, and send the unit values to the processing unit (120) according to a preset rule; the processing unit (120) is configured to perform data processing on the unit values by using a preset algorithm; and when the processed data or processing result sent to a receiving unit (210) meets a preset condition, the sensing units (110) are controlled to send the unit values to the receiving unit (210). The array-type sensor is enabled to perform certain processing on the received data and send same to a data receiver, thus reducing the amount of data received by the data receiver so as to reduce the receiving pressure and calculation pressure of the data receiver.

### CROSS REFERENCE TO RELATED APPLICATIONS

The present application claims priority to Chinese Patent Application No. CN202010155814.8, titled “DATA PROCESSING METHOD AND ARRAY-TYPE SENSOR”, filed on Mar. 6, 2020 with the Chinese Patent Office, which is incorporated herein by reference in its entirety.

The present application claims priority to Chinese Patent Application No. CN202010385945.5, entitled “ARRAY-TYPE SENSOR CHIP AND DATA OUTPUT METHOD THEREOF” filed on May 9, 2020 with the Chinese Patent Office, which is incorporated herein by reference in its entirety.

### FIELD

The present disclosure relates to the technical field of semiconductors, and in particular to a data processing method and an array sensor.

### BACKGROUND

In an array sensor, an electrical signal converted by each array unit in the sensor based on an external signal is required to be transmitted to a data processing unit provided outside the array unit for processing and calculation.

However, since the number of array units as the data uploader is generally large, a large amount of data to be processed is inputted into the data processing unit as the data receiver in the data transmission process, which results in the centralized transmission and calculation of the large amount of data by the data processing unit, and further results in the low response speed of the data processing unit.

### SUMMARY

An object of the present disclosure is to provide an array sensor chip and a data output method thereof, to reduce the amount of data transmitted to a receiving portion and/or reduce the calculation amount of the receiving portion, so as to improve the response speed of the receiving portion.

Embodiments of the present disclosure are implemented as follows.

In an aspect of embodiments of the present disclosure, an array sensor chip is provided. The array sensor chip includes a processing unit and multiple sensing units. Each of the multiple sensing units is connected to the processing unit and is configured to: receive an external signal, convert the external signal into a unit value, and transmit the unit value to the processing unit according to a predetermined rule. The processing unit is configured to: perform data processing on the unit value by using a predetermined algorithm, and control the sensing unit to transmit the unit value to a receiving portion in a case that the processing result meets a predetermined condition or transmit the processed data to a receiving portion.

Optionally, the array sensor chip further includes processing modules respectively connected to the sensing units. The processing unit is configured to: acquire data feature quantities of the multiple sensing units respectively calculated by the processing modules; screen out an eligible array unit according to a preset noise feature quantity and the data feature quantities respectively corresponding to the multiple sensing units; and control the eligible array unit to transmit the unit value to the receiving portion.

Optionally, the preset noise feature quantity is selected from one of a preset fixed value, the data feature quantity meeting the predetermined condition, and a noise feature quantity obtained by sampling for a stationary object.

Optionally, the processing modules is configured to: acquire multiple pieces of first data of corresponding array unit in a first preset time period, and calculate a mean of a data set based on the multiple pieces of first data; acquire multiple pieces of second data of the array unit in a second preset time period, and calculate a variance based on the mean and the multiple pieces of second data, as the data feature quantity of the array unit; and transmit the data feature quantity to the processing unit.

Optionally, the preset noise feature quantity is the data feature quantity meeting the predetermined condition, and the processing unit is further configured to: select the minimum value among the data feature quantities as the preset noise feature quantity, or acquire a value located at a preset quantile fractile from a set consisting of the data feature quantities as the preset noise feature quantity.

Optionally, the processing unit is configured to: acquire the data feature quantities of the array units respectively calculated by the processing modules; calculate, for each of the array units, a signal-to-noise ratio of the array unit based on the preset noise feature quantity and the data feature quantity of the array unit; and compare, for each of the array units, the signal-to-noise ratio of the array unit with a preset calibrated signal-to-noise ratio, and determine the array unit whose signal-to-noise ratio is greater than the preset calibrated signal-to-noise ratio as the eligible array unit; and control the eligible array unit to transmit the unit value to the receiving portion. The preset calibrated signal-to-noise ratio includes a preset fixed value and/or a value located at a preset quantile fractile in a set consisting of the signal-to-noise ratios of the array units.

Optionally, the predetermined rule includes a predetermined adjustment rule for a connection relationship and/or a corresponding relationship between the sensing units and the processing unit.

Optionally, the processing unit includes: a calculation unit and a storage unit. The calculation unit is configured to perform data processing on at least one of the received unit values of one or more of the sensing units and/or at least one stored value of the storage unit by using the predetermined algorithm. The storage unit is configured to store the at least one of the unit values of one or more of the sensing units, and/or at least one piece of data processed by one or more calculation units.

Optionally, the processing unit includes a calculation unit and a storage unit that are connected to each other, and one or more of the sensing units are connected to the calculation unit. The calculation unit is configured to: receive unit values respectively transmitted by the one or more of the sensing units, perform data processing based on the unit value and a storage value of the storage unit, and transmit the processed data to the storage unit. The storage unit is configured to transmit the processed data to the receiving portion.

Optionally, the processing unit includes a calculation unit and a storage unit that are connected to each other, and the sensing units are connected to the storage unit. The storage unit is configured to receive at least one of the unit values respectively transmitted by the sensing units. The calculation unit is configured to process the at least one of the unit values of the sensing units stored in the storage unit by using the predetermined algorithm, and transmit the processed unit value to the receiving portion.

Optionally, the processing unit includes multiple processing submodules connected in sequence, and the sensing units are connected to the processing submodule located at the head end. The processing submodules are configured to: sequentially perform calculation based on the unit value transmitted by each of the sensing units to generate preprocessing data, and transmit the preprocessing data to the receiving portion.

Optionally, each of the processing submodules includes a calculation unit and a storage unit that are connected to each other, the calculation unit of one of adjacent processing submodules is connected to the storage unit of the other of the adjacent processing submodules, and the sensing units are connected to the calculation unit of the processing submodule located at the head end. The calculation units of the processing submodules are configured to: sequentially perform calculation based on the corresponding unit value or data in the storage unit to generate preprocessing data, and transmit the preprocessing data to the receiving portion. The storage unit is configured to receive and store the data calculated by the corresponding calculation unit.

Optionally, the processing unit includes multiple first calculation units. The first calculation units are respectively connected to storage units, and each of the sensing units is connected to the first calculation units. Each of the first calculation units is configured to: receive the unit values respectively transmitted by the sensing units, process the unit value meeting a predetermined processing condition and/or the stored value of the corresponding storage unit, and transmit the processed data to the corresponding storage unit. Each of the storage units is configured to store the corresponding processed data and transmit the processed data to the receiving portion.

Optionally, the processing unit includes multiple first calculation units and a second calculation unit. The first calculation units are respectively connected to storage units, each of the sensing units is connected to the first calculation units, and the storage units are connected to the second calculation unit. Each of the first calculation units is configured to: receive the unit values respectively transmitted by the sensing units, perform calculation based on the unit value meeting a predetermined processing condition and/or the stored value of the corresponding storage unit to generate intermediate data, and transmit the intermediate data to the corresponding storage unit. Each of the storage units is configured to store the corresponding intermediate data, and transmit the intermediate data to the second calculation unit. The second calculation unit is configured to perform calculation based on pieces of the intermediate data to generate preprocessing data, and transmit the preprocessing data to the receiving portion.

Optionally, the processing unit includes multiple calculation units and multiple storage units, the calculation units are respectively connected to the sensing units in a one-to-one correspondence, and the calculation units are respectively connected to the storage units in a one-to-one correspondence. Each of the calculation units includes at least one calculation module, and the calculation module is connected to the corresponding sensing unit and the corresponding storage unit. The calculation module is configured to: receive the unit value transmitted by the corresponding sensing unit, perform calculation based on the unit value to generate preprocessing data, and transmit the preprocessing data to the corresponding storage unit, where calculation modules in a same calculation unit perform calculation by using different algorithms. Each of the storage units is configured to store the corresponding preprocessing data, and transmit the preprocessing data to the receiving portion.

Optionally, the processing unit includes a control unit and multiple calculation units, the sensing units are respectively connected to the calculation units in a one-to-one correspondence, and the calculation units are connected to the control unit, and the control unit is connected to the sensing units. Each of the sensing units is configured to receive an external signal, convert the external signal into a unit value, and transmit the unit value to the corresponding calculation unit. Each of the calculation units is configured to receive the unit value transmitted by the corresponding sensing unit, process the unit value by using a predetermined algorithm, and transmit the processed data to the control unit. The control unit is configured to control the sensing unit to transmit the unit value to the receiving portion in a case that the processed data meets a predetermined condition.

Optionally, the predetermined algorithm includes at least one of a numerical operation, a logical operation and a sorting operation.

Optionally, the sensing units, the calculation unit and the storage unit are arranged on at least one integrated circuit.

In another aspect of the embodiments of the present disclosure, a data output method for an array sensor chip is provided. The sensor chip includes: a processing unit and multiple sensing units, and each of the multiple sensing units is connected to the processing unit. The method includes:

receiving, by the processing unit, a unit value transmitted by each of the sensing units according to a predetermined rule, where the unit value is obtained by converting an external signal by the sensing unit;

performing, by the processing unit, data preprocessing on the unit value by using a predetermined algorithm; and

controlling the sensing unit to transmit the unit value to a receiving portion in a case that the processing result meets a predetermined condition or transmitting the processed data to a receiving portion.

Optionally, the method further includes: screening out, by the processing unit, an eligible array unit according to a preset noise feature quantity and data feature quantities of the multiple sensing units; and controlling, by the processing unit, the eligible sensing unit to transmit the unit value of the eligible sensing unit to the receiving portion

With the embodiments of the present disclosure, the following beneficial effects can be achieved.

The array sensor chip provided in the embodiment of the present disclosure includes a processing unit and multiple sensing units, and each of the multiple sensing units is connected to the processing unit. The sensing unit may be configured to: receive an external signal, convert the external signal into a unit value, and transmit the unit value to the processing unit according to a predetermined rule. The processing unit may be configured to: perform data processing on the unit value by using a predetermined algorithm, and control the sensing unit to transmit the unit value to a receiving portion in a case that the processing result meets a predetermined condition or transmit the processed data to the receiving portion. Next, the processing unit may transmit the processed data to a receiving portion, or the processing unit may control the sensing unit to transmit the unit value to the receiving portion in a case that the processing result meets a predetermined condition. With the array sensor chip, after the received external signal is converted into a unit value, data processing is performed according to the predetermined algorithm, on the unit value transmitted according to the predetermined rule, and the processed data is transmitted to the receiving portion. By preprocessing the unit value obtained by converting the external signal and transmitting the processed data to the receiving portion with the array sensor chip, the data processing of the receiving portion can be shared to reduce the data processing amount of the receiving portion, thereby improving the response speed of the receiving portion. Alternatively, with the array sensor chip, after the received external signal is converted into a unit value, data processing is performed according to the predetermined algorithm, on the unit value transmitted according to the predetermined rule, and the corresponding sensing unit is controlled to transmit the unit value to the receiving portion according to the result of the data processing and the predetermined condition. In this way, the number of unit values transmitted by the array sensor chip to the receiving portion can be reduced, so that the data processing amount of the receiving portion can be reduced, and thus the response speed of the receiving portion can be improved.

### BRIEF DESCRIPTION OF THE DRAWINGS

In order to illustrate technical solutions of the present disclosure more clearly, the drawings used for the embodiments are briefly introduced in the following. It should be understood that the drawings show only some embodiments of the present disclosure, and should not be regarded as a limitation of the scope. Other drawings may be obtained by those skilled in the art from these drawings without any creative work.

FIG. 1 is a schematic structural diagram of an array sensor chip according to an embodiment of the present disclosure;

FIG. 2 is a schematic structural diagram of an array sensor chip according to another embodiment of the present disclosure;

FIG. 3 is a schematic structural diagram of an array sensor chip according to another embodiment of the present disclosure;

FIG. 4 is a schematic structural diagram of an array sensor chip according to another embodiment of the present disclosure;

FIG. 5 is a schematic structural diagram of an array sensor chip according to another embodiment of the present disclosure;

FIG. 6 is a schematic structural diagram of an array sensor chip according to another embodiment of the present disclosure;

FIG. 7 is a schematic structural diagram of an array sensor chip according to another embodiment of the present disclosure;

FIG. 8 is a schematic structural diagram of an array sensor chip according to another embodiment of the present disclosure;

FIG. 9 is a schematic structural diagram of an array sensor chip according to another embodiment of the present disclosure;

FIG. 10 is a schematic structural diagram of an array sensor chip according to another embodiment of the present disclosure;

FIG. 11 is a schematic structural diagram of an array sensor chip according to another embodiment of the present disclosure;

FIG. 12 is a schematic flowchart of a data output method of an array sensor chip according to an embodiment of the present disclosure;

FIG. 13 is a schematic flowchart of a data output method of an array sensor chip according to another embodiment of the present disclosure;

FIG. 14 is a schematic flowchart of a data output method of an array sensor chip according to another embodiment of the present disclosure;

FIG. 15 is a schematic flowchart of a data output method of an array sensor chip according to another embodiment of the present disclosure;

FIG. 16 is a schematic flowchart of a data output method of an array sensor chip according to another embodiment of the present disclosure;

FIG. 17 is a schematic flowchart of a data output method of an array sensor chip according to another embodiment of the present disclosure; and

FIG. 18 is a schematic flowchart of a data output method of an array sensor chip according to another embodiment of the present disclosure.

In the drawings, the following reference numerals are illustrated.

| | | | |
|---|---|---|---|
| 110 | sensing unit; | 120 | processing unit; |
| 121 | calculation unit; | 1210 | calculation module; |
| 1211 | first calculation unit; | 1212 | second calculation unit; |
| 122 | storage unit; | 130 | control unit; |
| 210 | receiving portion; | 221 | processing module. |

### DETAILED DESCRIPTION OF EMBODIMENTS

In order to make objects, technical solutions and advantages of the embodiments of the present disclosure clearer, the technical solutions in the embodiments of the present disclosure are clearly and completely described below with reference to the drawings in the embodiments of the present disclosure. Apparently, the described embodiments are some but not all embodiments of the present disclosure. Components of the embodiments generally described and illustrated in the drawings herein may be arranged and designed in a variety of different configurations.

Therefore, the following detailed description for the embodiments of the present disclosure provided in the drawings is not intended to limit the scope of the present disclosure as claimed, but is merely representative of selected embodiments of the present disclosure. Based on the embodiments in the present disclosure, all other embodiments obtained by those of ordinary skill in the art without creative work shall fall in the protection scope of the present disclosure.

It should be noted that, similar numerals and letters refer to similar items in the following drawings. Therefore, if an item is defined in a drawing, the item is not required to be further defined and explained in subsequent drawings.

It should be noted that, terms such as “first”, “second” and “third” used in the description of the present disclosure are only used to distinguish one entity or operation from another entity or operation, and do not necessarily require or imply that there is any such actual relationship or order between these entities or operations. Moreover, terms “comprising”, “including” or any other variation thereof are intended to encompass a non-exclusive inclusion such that a process, method, article or device that includes a series of elements includes not only those elements, but also includes other elements that are not explicitly listed or that are inherent to such a process, method, article or apparatus. Without further limitation, an element defined by a statement “comprising a . . . ” does not preclude the presence of additional identical elements in a process, method, article or apparatus that includes the element.

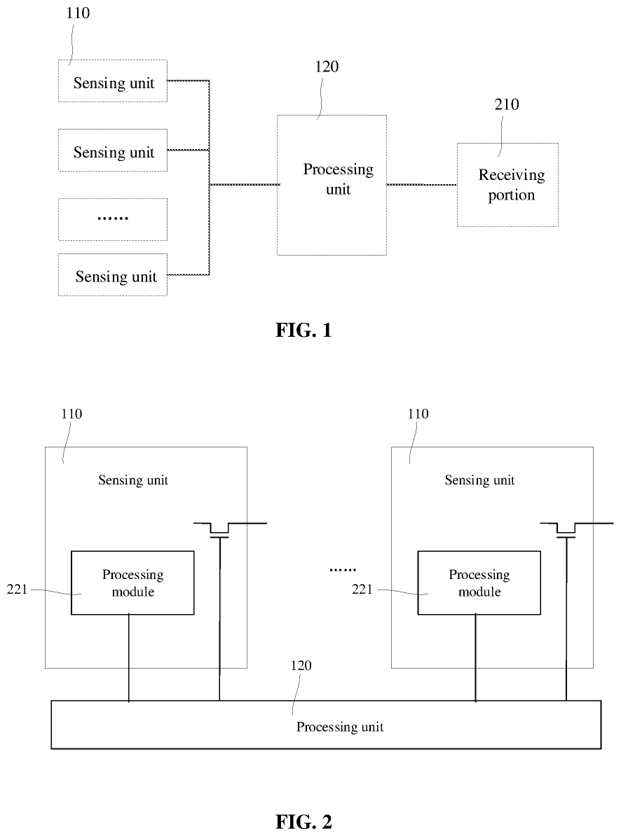

An array sensor chip is provided according to an embodiment of the present disclosure. As shown in FIG. 1, the array sensor chip may include: a processing unit 120 and multiple sensing units 110. Each of the multiple sensing units 110 is connected to the processing unit 120.

The sensing unit 110 is configured to: receive an external signal, convert the external signal into a unit value, and transmit the unit value to the processing unit 120 according to a predetermined rule. The processing unit 120 is configured to: perform data processing on the unit value by using a predetermined algorithm, and control the sensing unit 110 to transmit the unit value to a receiving portion 210 in a case that the processing result meets a predetermined condition or transmit the processed data to a receiving portion 210.

The multiple sensing units 110 of the array sensor chip are arranged in an array. According to different actual needs and application scenarios, the array sensor chip may be an optical sensor for photosensitive imaging, an acoustic sensor for sound detection, or the like. In addition, depending on different types of the array sensor chip, the sensing unit 110 may be a piezoresistive, piezoelectric, photoelectric, capacitive or electromagnetic element, so that the array sensor chip can realize a function of sensing a corresponding external signal. For example, in a case that the array sensor chip is the optical sensor, the sensing unit 110 may be correspondingly provided by the photoelectric element (such as a photodiode and a photoresistor) to serve as a pixel of the array sensor chip. For another example, in a case that the array sensor chip is the acoustic sensor, the sensing unit 110 may be provided by an element capable of converting an acoustic signal into an electrical signal, such as a microphone.

In practical applications, according to different scenarios, the receiving portion 210 for receiving data outputted by the array sensor chip may be a processor of an electronic device (such as a mobile phone, a digital camera, and a computer) or a data processing center, which is not limited herein.

It should be noted that, the sensing unit 110 transmits the unit value to the processing unit 120 according to the predetermined rule. The predetermined rule may be a screening rule for the sensing unit 110, that is, a rule for determining whether the sensing unit 110 transmits the unit value to the processing unit 120, for example, only some of the sensing units 110 are required to respectively transmit unit values to the processing unit 120 at a time. Further, a time domain restriction may be added for the predetermined rule. For example, different sensing units 110 respectively transmit unit values to the processing unit 120 at different times. Alternatively, the predetermined rule may be a transmitting rule for the sensing unit 110 to transmit the unit value. For example, the sensing units 110 sequentially transmit the unit values to the processing unit 120 in the form of row scanning or column scanning for the array of sensing units 110. In summary, the predetermined rule for the sensing unit 110 to transmit the unit value to the processing unit 120 is not limited in the embodiment of the present disclosure, and those skilled in the art may adaptively set or configure the predetermined rule for the sensing unit 110 to transmit the unit value to the processing unit 120 according to the predetermined algorithm for the processing unit 120 to process the unit value. With respect to the predetermined rule, the process of controlling the sensing unit 110 to transmit the unit value according to the predetermined rule may be implemented by providing a control switch between each sensing unit 110 and the processing unit 120 and controlling the control switch to be turned on or turned off according to the predetermined rule. If the sensing unit 110 and the processing unit 120 are connected wirelessly, the process of the sensing unit 110 transmitting the unit value according to the predetermined rule may be implemented by controlling a signal transmitting port of the sensing unit 110, which is not limited herein.

In the embodiment of the present disclosure, in a case that the processing unit 120 transmits the processed data to the receiving portion 210, the predetermined algorithm for the processing unit 120 to perform data processing on the unit value may be configured based on a calculation process of a target value to be finally obtained by the receiving portion 210. For example, the processing unit 120 may calculate the received unit value by the predetermined algorithm to obtain an intermediate value required for the operation of the receiving portion 210, and the processing unit 120 transmits the intermediate value to the receiving portion 210, so that the receiving portion 210 directly performs the operation according to the intermediate value to finally obtain the target value, thereby reducing the calculation amount of the receiving portion 210 so as to have a relative fast response speed.

In a case that the processing unit 120 controls the sensing unit 110 to transmit the unit value to the receiving portion 210 when the data processed by the processing unit 120 meets the predetermined condition, the predetermined algorithm for the processing unit 120 to perform data processing on the unit value may be configured according to the predetermined condition. For example, if the predetermined condition is a limiting condition of a signal-to-noise ratio of the unit value corresponding to each sensing unit 110, the processing unit 120 may calculate the signal-to-noise ratio of the unit value transmitted by each sensing unit 110 according to the predetermined algorithm and screen the signal-to-noise ratio corresponding to each unit value according to the predetermined algorithm, so that the sensing unit 110 corresponding to the unit value whose signal-to-noise ratio meets the predetermined condition transmits the corresponding unit value to the receiving portion 210. Further, the predetermined condition may be a limiting condition of another parameter of the unit value, which is not limited herein. Correspondingly, the predetermined algorithm of the processing unit 120 may be used for calculating the another parameter of the unit value.

The array sensor chip provided in the embodiment of the present disclosure includes a processing unit 120 and multiple sensing units 110, and each of the multiple sensing units 110 is connected to the processing unit 120. The sensing unit 110 may be configured to receive an external signal, convert the external signal into a unit value, and transmit the unit value to the processing unit 120 according to a predetermined rule. The processing unit 120 may be configured to perform data processing on the unit value by using a predetermined algorithm. Next, the processing unit 120 may transmit the processed data to a receiving portion 210, or the processing unit 120 may control the sensing unit 110 to transmit the unit value to the receiving portion 210 in a case that the processing result meets a predetermined condition. With the array sensor chip, after the received external signal is converted into a unit value, data processing is performed according to the predetermined algorithm, on the unit value transmitted according to the predetermined rule, and the processed data is transmitted to the receiving portion 210. By preprocessing the unit value obtained by converting the external signal and transmitting the processed data to the receiving portion 210 with the array sensor chip, the data processing of the receiving portion 210 can be shared to reduce the data processing amount of the receiving portion 210, thereby improving the response speed of the receiving portion 210. Alternatively, with the array sensor chip, after the received external signal is converted into a unit value, data processing is performed according to the predetermined algorithm, on the unit value transmitted according to the predetermined rule, and the corresponding sensing unit 110 is controlled to transmit the unit value to the receiving portion 210 according to the result of the data processing and the predetermined condition. In this way, the number of unit values transmitted by the array sensor chip to the receiving portion 210 can be reduced, so that the data processing amount of the receiving portion 210 can be reduced, and thus the response speed of the receiving portion 210 can be improved.

Optionally, the predetermined rule includes a predetermined adjustment rule for a connection relationship and/or a corresponding relationship between the sensing units 110 and the processing unit 120.

The corresponding relationship may be a corresponding relationship between the sensing units 110 and the processing unit 120 in terms of the order and/or the number of times of transmitting unit values. The connection relationship may be an on-off state of the connection of the sensing unit 110 to the processing unit 120.

The predetermined adjustment rule may be a rule for adjusting the corresponding relationship and/or connection relationship, so that the process of the sensing unit 110 in the array sensor chip transmitting the unit value to the processing unit 120 can be dynamically adjusted according to the predetermined adjustment rule, so as to facilitate the processing unit 120 performing an complex operation on the unit value transmitted by the sensing unit 110.

In another embodiment, the array sensor may include: a processing unit 120 and multiple sensing units 110, and each sensing unit 110 includes a processing module 221, as shown in FIG. 2. The processing modules 221 respectively in the sensing units 120 are all communicationally connected to the processing unit 120.

The processing unit 120 is configured to: acquire data feature quantities of the sensing units 110 respectively calculated by the processing modules 221; screen out an eligible sensing unit 110 according to a preset noise feature quantity and the data feature quantities respectively corresponding to the sensing units 110; and control the eligible sensing unit 110 to transmit data to a data receiving portion.

The array sensor provided in the embodiment of the present disclosure may be used to perform the data processing method described above. The array sensor may include a processing unit 120 and multiple sensing units 110 respectively having processing modules 221. The processing modules 221 of the sensing units 110 are all communicationally connected with the processing unit 120. Firstly, the processing unit 120 acquires the data feature quantity of the corresponding sensing unit 110 calculated by each processing module 221, that is, the processing unit 120 acquires the data feature quantity calculated by the processing module 221 corresponding to each sensing unit 110. Next, the processing unit 120 performs screening according to the data feature quantity corresponding to each sensing unit 110 acquired by the processing unit 120 and the preset noise feature quantity to screen out an eligible sensing unit 110, and controls the eligible sensing unit 110 to transmit data to the data receiving portion. In this way, the data transmitted by the array sensor to the data receiving portion is from some of the sensing units 110, instead of all the sensing units 110 transmitting data to the data receiving portion, so that the amount of data received and processed by the data receiving portion at the same time is reduced. Further, the receiving pressure when the data receiving portion receives the data of the array sensor and the calculation pressure for subsequent calculation and processing of the data are reduced, so as to improve the response speed of the data receiving portion.

Optionally, the preset noise feature quantity is any one of a preset fixed value, a data feature quantity meeting the predetermined condition, and a noise feature quantity obtained by sampling for a stationary object.

Optionally, the processing module 221 is configured to: acquire the data of the sensing unit 110 and calculate the data feature quantity according to the data; and transmit the data feature quantity to the processing unit 120.

Optionally, the processing module 221 is configured to: acquire multiple pieces of first data of the sensing unit 110 in a first preset time period, and calculate a mean of a data set based on the multiple pieces of first data; acquire multiple pieces of second data of the sensing unit 110 in a second preset time period, and calculate a variance based on the mean and the multiple pieces of second data, as the data feature quantity of the sensing unit 110; and transmit the data feature quantity to the processing unit 120.

Optionally, the processing module 221 is configured to: acquire the data of the corresponding sensing unit 110, and calculate a mean and a square mean of the data; and transmit the mean and the square mean to the processing unit 120.

The processing unit 120 is configured to: calculate a variance according to the mean and the square mean, as the data feature quantity of the corresponding sensing unit 110; screen out an eligible sensing unit 110 according to a preset noise feature quantity and the data feature quantities respectively corresponding to the sensing units 110; and control the eligible sensing unit 110 to transmit data to the data receiving portion.

Optionally, the processing module 221 is configured to: acquire multiple pieces of first data of the sensing unit 110 in a first preset time period, and calculate a mean of the multiple pieces of first data; and acquire multiple pieces of second data of the sensing unit 110 in a second preset time period, and calculate a square mean of the multiple pieces of second data.

Optionally, the preset noise feature quantity is a data feature quantity meeting the predetermined condition, and the processing unit 120 is further configured to select the minimum value among the data feature quantities as the preset noise feature quantity.

Optionally, the preset noise feature quantity is a data feature quantity meeting the predetermined condition, and the processing unit 110 is further configured to acquire a value located at a preset quantile fractile from a set consisting of the data feature quantities as the preset noise feature quantity.

Optionally, the processing unit 120 is configured to: acquire the data feature quantities of the sensing units 110 respectively calculated by the processing modules 221; calculate, for each sensing unit 110, a signal-to-noise ratio of the sensing unit based on the preset noise feature quantity and the data feature quantity of the sensing unit; compare, for each sensing unit 110, the signal-to-noise ratio of the sensing unit with a preset calibrated signal-to-noise ratio, and determine the sensing unit 110 whose signal-to-noise ratio is greater than the calibrated signal-to-noise ratio as the eligible sensing unit 110; and control the eligible sensing unit 110 to transmit data to the data receiving portion.

The preset calibrated signal-to-noise ratio includes a preset fixed value and/or a value at a preset quantile fractile in a set consisting of the signal-to-noise ratios of the sensing units 110, and other similar functional modules are not described in detail herein.

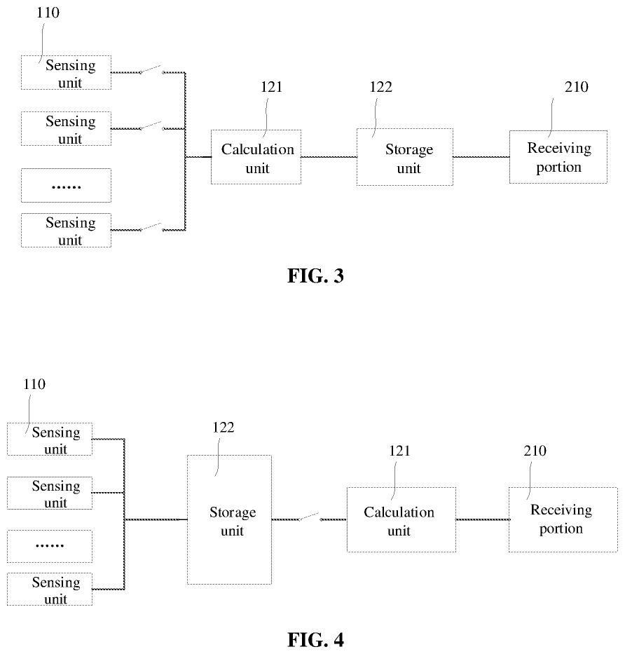

Optionally, as shown in FIG. 3, the processing unit 120 includes a calculation unit 121 and a storage unit 122.

The calculation unit 121 is configured to perform data processing on at least one of the received unit values of one or more sensing units 110 and/or at least one stored value of the storage unit 122 by using the predetermined algorithm. The storage unit 122 is configured to: store at least one unit value of the one or more sensing units 110, and/or at least one piece of data processed by one or more calculation units 121.

The processing unit 120 is provided as a module including the calculation unit 121 and the storage unit 122, so that a relatively complex operation can be performed when processing the received unit value. For example, the unit value is received and processed by the calculation unit 121, and a calculation result is stored in the storage unit 122. Alternatively, the unit value is received and processed by the calculation unit 121, and an intermediate calculation result is stored in the storage unit 122. The intermediate result stored in the storage unit 122 may be called in the subsequent calculation performed by the calculation unit 121, so that the calculation unit 121 can perform multi-step complex operations according to the multiple unit values transmitted by the sensing units 110 at different times. Further, the storage unit 122 may store a parameter required for the calculation by the calculation unit 121, so that the calculation unit 121 can call the parameter. In addition, the unit value of the sensing unit 110 may be transmitted to the storage unit 122 or to the calculation unit 121, which may be set by those skilled in the art according to a specific configuration of the predetermined algorithm for processing the unit value by the processing unit 120.

Optionally, as shown in FIG. 3, the processing unit 120 includes a calculation unit 121 and a storage unit 122 that are connected to each other, and one or more sensing units 110 are connected to the calculation unit 121.

The calculation unit 121 is configured to: receive unit values respectively transmitted by one or more sensing units 110, perform data processing based on the unit value and a stored value of the storage unit 122, and transmit the processed data to the storage unit 122. The storage unit 122 is configured to transmit the processed data to the receiving portion 210.

In practical applications, data processing on the received unit value may be performed by the calculation unit 121, and the intermediate result in the process of processing the unit value may be stored in the storage unit 122, so that the calculation unit 121 can call the intermediate result in the subsequent process for the unit value. Further, the storage unit 122 may store a parameter required in the process of processing the unit value by the calculation unit 121, so that the calculation unit 121 can call the parameter. The data stored in the storage unit 122 is not limited herein.

Exemplarily, the sensing units 110 connected to the calculation unit 121 may transmit the unit values to the calculation unit 121 in sequence according to different arrangement regions of the array, so that the calculation unit 121 can process unit values of sensing units 110 in a region at each time, and transmit the processing result obtained after each processing to the storage unit 122. The processed data can be transmitted by the storage unit 122 to the receiving portion 210, so as to reduce the calculation amount of the data processing by the receiving portion 210, so that a partition scanning function can be realized in the array sensor chip while improving the response speed of the receiving portion 210 by preprocessing the unit value. In addition, after the calculation unit 121 processes the unit values of the sensing units 110 in a corresponding region at each time, the processing result is transmitted to the storage unit 122. When processing the unit values corresponding to the sensing units 110 in another region, the calculation unit 121 may call the processing result stored in the storage unit 122 to perform processing on the unit values.

Optionally, as shown in FIG. 4, the processing unit 120 includes a calculation unit 121 and a storage unit 122 that are connected to each other, and the sensing units 110 are connected to the storage unit 122.

The storage unit 122 is configured to receive at least one unit value transmitted by the sensing units 110. The calculation unit 121 is configured to: process the at least one unit value of the sensing units 110 stored in the storage unit 122 by using the predetermined algorithm, and transmit the processed data to the receiving portion 210.

In practical applications, the storage unit 122 may be connected to the sensing units 110 to store the unit values respectively transmitted by the sensing units 110 according to a predetermined rule, so that the calculation unit 121 can process the multiple unit values transmitted by the sensing unit 110 multiple times (the calculation unit can also process one unit value transmitted at one time). In a case that the sensing unit 110 transmits multiple unit values, the sensing unit 110 may transmit the unit values to the storage unit 122 in multiple times according to a time sequence. The calculation unit 121 may process the unit values stored in the storage unit 122 after a time period, or process the unit value transmitted by the sensing unit 110 at each time and stored in the storage unit 122 in time, which is not limited herein.

Exemplarily, the sensing unit 110 may transmit the unit values to the storage unit 122 multiple times according to the time sequence. After the storage unit 122 stores the multiple unit values transmitted by the sensing unit 110 multiple times, the calculation unit 121 processes the multiple unit values transmitted by the sensing unit 110 and stored in the storage unit 122 to obtain processed data, and transmits the processed data to the receiving portion 210, thereby reducing the number of received unit values and the calculation amount of the receiving portion 210, and improving the response speed of the receiving portion 210.

For example, the array sensor chip is used for laser ranging, the external signal received by the sensing unit 110 may be a ranging laser light reflected by the target. The ranging laser light may be transmitted multiple times, and correspondingly the sensing unit 110 may receive the ranging laser light multiple times, and convert the ranging laser light into a unit value and transmit the unit value to the calculation unit 121. In this case, the process of the calculation unit 121 for the multiple unit values transmitted by the sensing unit 110 according to the time sequence may be performed by the following processes. A flight time of the ranging laser light is calculated according to the unit value of a corresponding time, to obtain a set of flight times respectively corresponding to different times. A mode (that is, the flight time appearing most frequently) in the set is transmitted to the receiving portion 210, so that the receiving portion 210 can calculate a distance to a target object based on only the received flight time, thus reducing the calculation amount of the receiving portion 210 and improving the response speed of the receiving portion. Moreover, in this way, laser ranging in the form of DTOF (direct time of flight) can be realized.

Optionally, the processing unit 120 includes multiple processing submodules connected in sequence, and the sensing units 110 are connected with the processing submodule located at the head end.

The processing submodules are configured to: sequentially perform calculation based on the unit value transmitted by the sensing unit 110 to generate preprocessing data, and transmit the preprocessing data to the receiving portion 210.

By providing the processing unit 120 to be formed by multiple interconnected processing submodules, the processing submodules can call each other to sequentially perform calculation based on the unit values transmitted by the sensing units 110 to implement a neural network algorithm (predetermined algorithm).

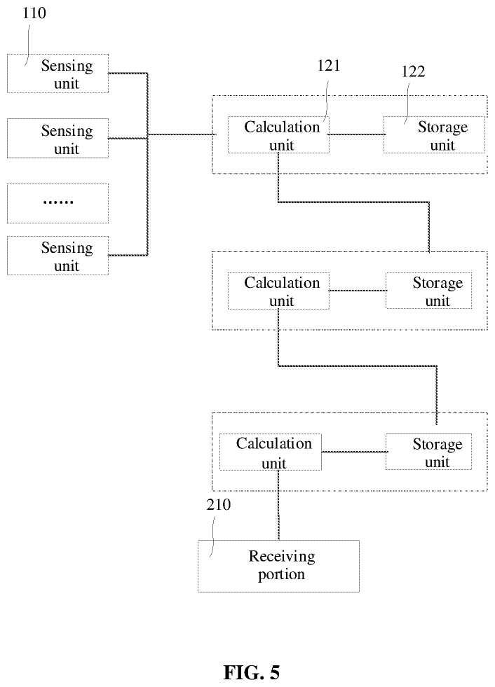

Exemplarily, as shown in FIG. 5, each processing submodule includes a calculation unit 121 and a storage unit 122 that are connected to each other. The calculation unit 121 of one of adjacent processing submodules is connected to the storage unit 122 of the other of the adjacent processing submodules. The sensing units 110 are connected to the calculation unit 121 of the processing submodule located at the head end.

The calculation units 121 are configured to sequentially perform calculation based on the corresponding unit value or data in the storage unit 122 to generate preprocessing data, and transmit the preprocessing data to the receiving portion 210. The storage unit 122 is configured to receive and store the data calculated by the corresponding calculation unit 121.

For example, the calculation unit 121 connected to the sensing units 110 may receive the unit values transmitted by the sensing units 110 to perform calculation, and transmit the calculation result to two storage units 122 (the storage unit 122 at the same level as the calculation unit 121 and the storage unit 122 corresponding to the calculation unit 121 at the next level) connected to the calculation unit. The calculation unit 121 at the next level may continue to perform the corresponding calculation according to the storage value stored in the corresponding storage unit 122 of the same level, until the last calculation unit 121 completes the calculation and transmits the processed result to the receiving portion 210, so that the multi-level calculation for the unit values transmitted by the sensing units 110 can be performed to realize the neural network algorithm. Further, each storage unit 122 may store a weight required for calculation by the corresponding calculation unit 121 of the same level, or the like, which is not limited herein. Those skilled in the art may preset the data in the storage unit 122 according to the algorithm actually calculated by each calculation unit 121.

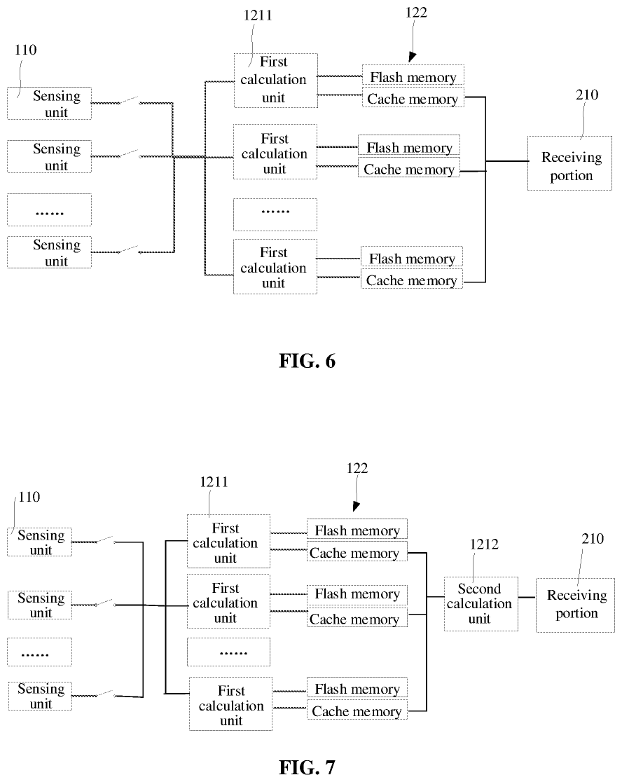

Optionally, as shown in FIG. 6, the processing unit 120 includes multiple first calculation units 1211. The first calculation units 1211 are respectively connected to storage units 122. Any one sensing unit 110 is connected to the first calculation units 1211.

The first calculation unit 1211 is configured to: receive the unit values respectively transmitted by the sensing units 110, process the unit value meeting a predetermined processing condition and/or the stored value of the corresponding storage unit 122, and transmit the processed data to the corresponding storage unit 122. The storage unit 122 is configured to store the corresponding processed data, and transmit the processed data to the receiving portion 210.

Exemplarily, the storage unit 122 may include both a flash memory and a cache memory.

With respect to the unit value meeting the predetermined processing condition, the processing condition may be set according to a feature of the corresponding sensing unit 110 transmitting the unit value. In this case, since the same sensing unit 110 generally transmits different unit values at different times, the feature of the unit value processed by the first calculation unit 1211 at this time may be different from that at another time. Further, the processing condition may also be set according to a feature of the received unit value. In this case, since the same sensing unit 110 generally transmits different unit values at different times, the sensing unit 110 corresponding to the unit value processed by the first calculation unit 1211 at this time may be different from that at another time.

By processing the unit value meeting the predetermined processing condition and/or the stored value of the corresponding storage unit 122 by means of the first calculation unit 1211, the screening can be performed on the unit value by using the predetermined processing condition, thereby further reducing the amount of data transmitted to the receiving portion 210, and improving the response speed of the receiving portion 210. In addition, the predetermined processing condition corresponding to each of the first calculation units 1211 may be set to be dynamically adjusted, so that the first calculation unit 1211 only calculates the unit values corresponding to some of the sensing units 110 according to the predetermined processing condition each time, and performs calculation on the unit values corresponding to different sensing units 110 multiple times, so as to implement convolution calculation on the unit values transmitted by the sensing units 110. The storage unit 122 may also store a parameter required by the first calculation unit 1211 for calculation.

Optionally, as shown in FIG. 7, the processing unit 120 includes a second calculation unit 1212 and multiple first calculation units 1211. The first calculation units 1211 are respectively connected with storage units 122. Any one sensing unit 110 is connected with the first calculation units 1211. The storage units 122 are connected to the second calculation unit 1212.

The first calculation unit 1211 is configured to: receive the unit values respectively transmitted by the sensing units 110, perform calculation based on the unit value meeting a predetermined processing condition and/or the stored value of the corresponding storage unit 122 to generate intermediate data, and transmit the intermediate data to the corresponding storage unit 122. The storage unit 122 is configured to store the corresponding intermediate data, and transmit the intermediate data to the second calculation unit 1212. The second calculation unit 1212 is configured to perform calculation based on pieces of the intermediate data to generate preprocessing data, and transmit the preprocessing data to the receiving portion 210.

Exemplarily, the storage unit 122 may include both a flash memory and a cache memory.

With respect to the unit value meeting the predetermined processing condition, the processing condition may be set according to a feature of the corresponding sensing unit 110 transmitting the unit value. In this case, since the same sensing unit 110 generally transmits different unit values at different times, the feature of the unit value processed by the first calculation unit 1211 at this time may be different from that at another time. Further, the processing condition may also be set according to a feature of the received unit value. In this case, since the same sensing unit 110 generally transmits different unit values at different times, the sensing unit 110 corresponding to the unit value processed by the first calculation unit 1211 at this time may be different from that at another time.

By processing the unit value meeting the predetermined processing condition and/or the stored value of the corresponding storage unit 122 by means of the first calculation unit 1211 and performing calculation on the calculation result of each first calculation unit 1211 stored in the storage unit 122 by means of the second calculation unit 1212, the screening can be performed on the unit value by using the predetermined processing condition, thereby further reducing the amount of data transmitted to the receiving portion 210, and improving the response speed of the receiving portion 210. In addition, the predetermined processing conditions corresponding to each of the first calculation units 1211 may be set to be dynamically adjusted, so that the first calculation unit 1211 only calculates the unit values corresponding to some of the sensing units 110 according to the predetermined processing condition each time, and performs calculation on the unit values corresponding to different sensing units 110 multiple times, so as to implement convolution calculation on the unit values transmitted by the sensing units 110. The storage unit 122 may also store a parameter required by the first calculation unit 1211 for calculation. By performing calculation on the results respectively obtained by the first calculation units 1211 by means of the second calculation unit 1212, the mutual operation of the calculation results between the first calculation units 1211 can be realized, thereby realizing a more complex convolution operation.

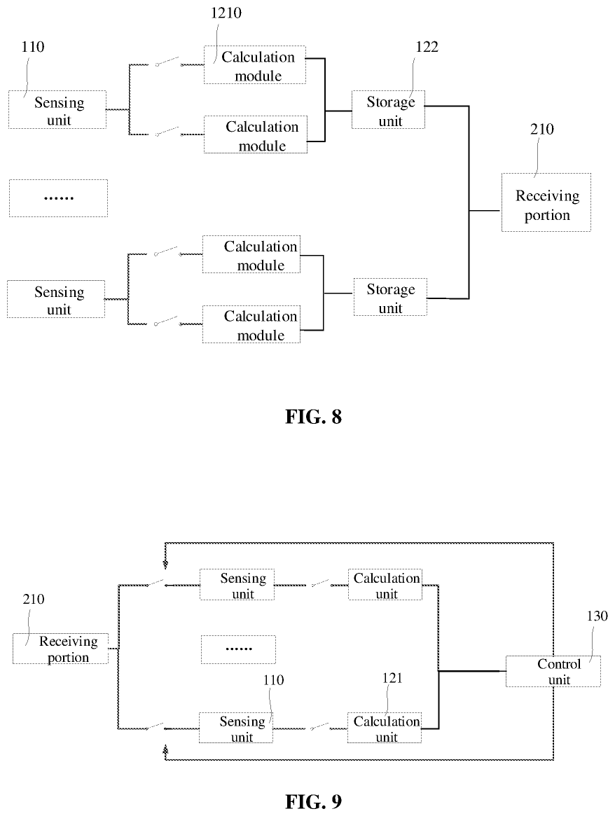

Optionally, as shown in FIG. 8, the processing unit 120 includes multiple calculation units 121 and multiple storage units 122. The calculation units 121 are respectively connected with the sensing units 110 in a one-to-one correspondence, and the calculation units 121 are respectively connected with the storage units 122 in a one-to-one correspondence. The calculation unit 121 includes at least one calculation module 1210, and the calculation module 1210 is connected to the corresponding sensing unit 110 and the corresponding storage unit 122.

The calculation module 1210 is configured to: receive the unit value transmitted by the corresponding sensing unit 110, perform calculation based on the unit value to generate preprocessing data, and transmit the preprocessing data to the corresponding storage unit 122, where calculation modules 1210 in the same calculation unit 121 perform calculation by using different algorithms. The storage unit 122 is configured to store the corresponding preprocessing data, and transmit the preprocessing data to the receiving portion 210.

By processing the unit value transmitted by the corresponding sensing unit 110 by means of the calculation module 1210 of each calculation unit 121, each calculation unit 121 can only process one corresponding sensing unit 110, reducing the data processing calculation amount of each calculation unit 121, and improving the response speed of each calculation unit 121, thereby increasing the response speed of the array sensor chip. In a case that each calculation unit 121 includes two or more calculation modules 1210, the calculation modules 1210 may perform different algorithm processing on the unit value transmitted by the corresponding sensing unit 110, implementing the preprocessing instead of the receiving portion 210 performing different calculations on the unit value of the sensing unit 110, and further reducing the calculation load pressure of the receiving portion 210 that is required to perform multiple calculations on each unit value. For example, each calculation unit 121 is provided with two calculation modules 1210, one of which is used to calculate the mean of the unit value, and the other of which is used to calculate the variance of the unit value, so that the receiving portion 210 can directly calculate a parameter such as the signal-to-noise ratio of the sensing unit 110 corresponding to the unit value according to the received mean and variance, reducing the amount of calculation for the receiving portion 210 to directly calculate the signal-to-noise ratio according to the unit value.

Optionally, as shown in FIG. 9, the processing unit 120 includes a control unit 130 and multiple calculation units 121. The sensing units 110 are respectively connected to the calculation units 121 in a one-to-one correspondence. The calculation units 121 are connected to the control unit 130. The control unit 130 is connected to the sensing units 110.

The sensing unit 110 is configured to: receive an external signal, convert the external signal into a unit value, and transmit the unit value to the corresponding calculation unit 121. The calculation unit 121 is configured to receive the unit value transmitted by the corresponding sensing unit 110, process the unit value by using a predetermined algorithm, and transmit the processed data to the control unit 130. The control unit 130 is configured to control the corresponding sensing unit 110 to transmit the unit value to the receiving portion 210 in a case that the processed data meets a predetermined condition.

The control unit 130 may control a control switch provided between each sensing unit 110 and the receiving portion 210, for example, a Metal-Oxide-Semiconductor (MOS) transistor, so as to control the sensing unit 110 to transmit the unit value to the receiving portion 210. In this way, the transmitting of the unit value from the sensing unit 110 to the receiving portion 210 can be more conveniently and accurately controlled according to the processing result for the unit value.

Exemplarily, the calculation unit 121 may calculate the signal-to-noise ratio of the unit value transmitted by the corresponding sensing unit 110. The predetermined algorithm may be as follows. A variance and a mean of multiple unit values transmitted by the same sensing unit 110 are calculated, and a signal-to-noise ratio thereof is calculated according to the variance and the mean, so that the control unit 130 can screen the sensing unit 110 according to the signal-to-noise ratio (correspondingly, the predetermined condition is whether the signal-to-noise ratio is greater than the preset signal-to-noise ratio), to control the sensing unit 110 transmitting the unit value having a relatively high signal-to-noise ratio to transmit the unit value to the receiving portion 210, which can not only reduce the amount of data transmitted to the receiving portion 210 to improve the response speed of the receiving portion 210, but also reduce the impact of an interference signal on the processing result when the receiving portion 210 processes data. Further, whether the processed data meets the predetermined condition may be determined by the calculation unit 121 or may be determined by the control unit 130, which is not limited herein.

It should be noted that, the storage unit 122 in the embodiments of the present disclosure may include one or a combination of two or more of a capacitor, a latch, a flash memory, or a cache memory, which is not limited herein.

In addition, the predetermined algorithm for the processing unit 120 to perform data processing on the unit value may be predetermined according to the intermediate calculation process for obtaining the target value calculated by the receiving portion 210, or according to the specific setting of the predetermined condition. Exemplarily, the predetermined algorithm may include at least one of a numerical operation, a logical operation, or a sorting operation.

The numerical operation may be an arithmetic operation, a mean operation, a variance operation, a convolution operation, a Fourier transform performed on the unit value, or the like. In the embodiments of the present disclosure, the numerical operation may also be other operations performed on the unit value, for example, a partial operation of the convolution operation or the Fourier transform, or a combination of the above example operations, which is not limited herein.

It should further be noted that the sensing units 110, the calculation unit 121 and the storage unit 122 may be arranged on at least one integrated circuit.

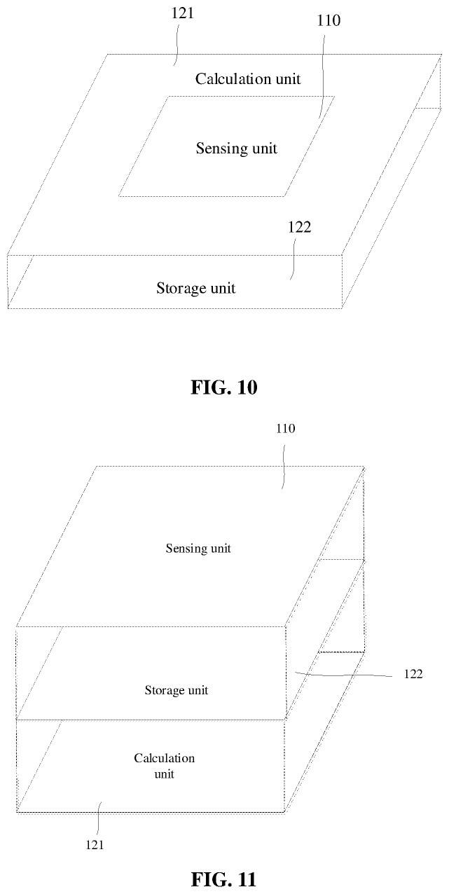

For example, as shown in FIG. 10, the sensing units 110, the calculation unit 121 and the storage unit 122 are arranged on the same integrated circuit and are distributed according to a certain layout. Further, as shown in FIG. 11, the sensing units 110, the calculation unit 121 and the storage unit 122 may be arranged on different integrated circuits, which is not limited herein.

The sensing units 110 may be arranged in the same area in an array.

Optionally, the processing module 221 shown in FIG. 2 may be included in the processing unit 120, and further the processing module 221 may be included in the calculation unit 121. Preferably, the processing module 221 may be the same as the first calculation unit 1211, which is exemplary and is not limited herein.

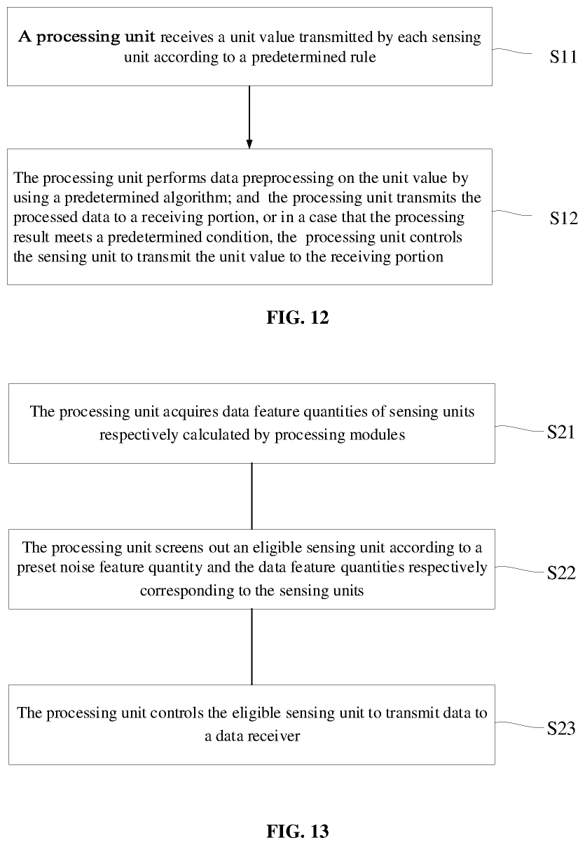

As shown in FIG. 12, a data output method of an array sensor chip is provided according to an embodiment of the present disclosure. The method may include the following steps S11 and S12.

In S11, a processing unit receives a unit value transmitted by each sensing unit according to a predetermined rule, where the unit value is obtained by converting an external signal by the sensing unit.

In S12, the processing unit performs data preprocessing on the unit value by using a predetermined algorithm. The processing unit transmits the processed data to a receiving portion, or in a case that the processing result meets a predetermined condition, the processing unit controls the sensing unit to transmit the unit value to the receiving portion.

In the method, the sensing unit in the array sensor chip may firstly receive an external signal, convert the external signal into a unit value, and transmit the unit value to the processing unit according to a predetermined rule. The processing unit in the array sensor chip may perform data preprocessing on the unit value by using the predetermined algorithm. Next, the processing unit transmits the processed data to the receiving portion, or in the case that the processing result meets a predetermined condition, the processing unit controls the sensing unit to transmit the unit value to the receiving portion. With the method, after the received external signal is converted into a unit value, data processing is performed according to the predetermined algorithm, on the unit value transmitted according to the predetermined rule, and the processed data is transmitted to the receiving portion. By preprocessing the unit value obtained by converting the external signal and transmitting the processed data to the receiving portion by the array sensor chip, the data processing of the receiving portion can be shared to reduce the data processing amount of the receiving portion, thereby improving the response speed of the receiving portion. Alternatively, with the method, after the received external signal is converted into a unit value, data processing is performed according to the predetermined algorithm, on the unit value transmitted according to the predetermined rule, and the corresponding sensing unit is controlled to transmit the unit value to the receiving portion according to the result of the data processing and the predetermined condition. In this way, the number of unit values transmitted by the array sensor chip to the receiving portion can be reduced, so that the data processing amount of the receiving portion can be reduced, and thus the response speed of the receiving portion can be improved.

Optionally, the predetermined rule includes a predetermined adjustment rule for a connection relationship and/or a corresponding relationship between the sensing units and the processing unit.

Optionally, the processing unit includes a calculation unit and a storage unit, and the process of the processing unit performing data processing on the unit value by using the predetermined algorithm may be performed by:

performing, by the calculation unit by using the predetermined algorithm, data processing on at least one of the received unit values of one or more sensing units and/or at least one stored value of the storage unit; and

storing, by the storage unit, at least one unit value of the one or more sensing units, and/or at least one piece of data processed by one or more calculation units.

Optionally, the processing unit includes a calculation unit and a storage unit that are connected to each other, and one or more sensing units are connected to the calculation unit. The process of the processing unit performing data preprocessing on the unit value by using the predetermined algorithm and transmitting the processed data to the receiving portion may be performed by:

receiving, by the calculation unit, unit values respectively transmitted by one or more sensing units, performing, by the calculation unit, data processing based on the unit value and a stored value of the storage unit, and transmitting, by the calculation unit, the processed data to the storage unit; and

transmitting, by the storage unit, the processed data to the receiving portion.

Optionally, the processing unit includes a calculation unit and a storage unit that are connected to each other, and the sensing units are connected to the storage unit. The process of the processing unit performing data preprocessing on the unit value by using the predetermined algorithm and transmitting the processed data to the receiving portion may be performed by:

receiving, by the storage unit, at least one unit value transmitted by the sensing units; and

processing, by the calculation unit by using the predetermined algorithm, the at least one unit value of the sensing units stored in the storage unit, and transmitting, by the calculation unit, the processed data to the receiving portion.

Optionally, the processing unit includes multiple processing submodules connected in sequence, and the sensing units are connected with the processing submodule located at the head end. The process of the processing unit performing data preprocessing on the unit value by using the predetermined algorithm and transmitting the processed data to the receiving portion may be performed by:

sequentially performing calculation by the processing submodules based on the unit value transmitted by the sensing unit to generate preprocessing data, and transmitting, by the processing submodules, the preprocessing data to the receiving portion.

Optionally, the processing submodule includes a calculation unit and a storage unit that are connected to each other, and the calculation unit of one of adjacent processing submodules is connected to the storage unit of the other of the adjacent processing submodules, and the sensing units are connected to the calculation unit of the processing submodule located at the head end. The process of the processing submodules sequentially performing calculation based on the unit value transmitted by the sensing unit to generate preprocessing data and transmitting the preprocessing data to the receiving portion may be performed by:

sequentially perform calculation by the processing submodules based on the corresponding unit value or data in the storage unit to generate preprocessing data, and transmitting, by the processing submodules, the preprocessing data to the receiving portion; and

receiving and storing, by the storage unit, the data calculated by the corresponding calculation unit.

Optionally, the processing unit includes multiple first calculation units, the first calculation units are respectively connected with storage units, and any one sensing unit is connected with the first calculation units. The process of the processing unit performing data preprocessing on the unit value by using the predetermined algorithm and transmitting the processed data to the receiving portion may be performed by:

receiving, by the first calculation unit, the unit values respectively transmitted by the sensing units, processing, by the first calculation unit, the unit value meeting a predetermined processing condition and/or the stored value of the corresponding storage unit, and transmitting, by the first calculation unit, the processed data to the corresponding storage unit; and

storing, by the storage unit, the corresponding processed data, and transmitting, by the storage unit, the processed data to the receiving portion.

Optionally, the processing unit includes a second calculation unit and multiple first calculation units, the first calculation units are respectively connected with storage units, any one sensing unit is connected with the first calculation units, and the storage units are connected with the second calculation unit. The process of the processing unit performing data preprocessing on the unit value by using the predetermined algorithm and transmitting the processed data to the receiving portion may be performed by:

receiving, by the first calculation unit, the unit values respectively transmitted by the sensing units, performing calculation by the first calculation unit based on the unit value meeting a predetermined processing condition and/or the stored value of the corresponding storage unit to generate intermediate data, and transmitting, by the first calculation unit, the intermediate data to the corresponding storage unit;

storing, by the storage unit, the corresponding intermediate data, and transmitting, by the storage unit, the intermediate data to the second calculation unit; and

perform calculation by the second calculation unit based on pieces of the intermediate data to generate preprocessing data, and transmitting, by the second calculation unit, the preprocessing data to the receiving portion.

Optionally, the processing unit includes multiple calculation units and multiple storage units, the calculation units are respectively connected with the sensing units in a one-to-one correspondence, and the calculation units are respectively connected with the storage units in a one-to-one correspondence, the calculation unit includes at least one calculation module, and the calculation module is connected to the corresponding sensing unit and the corresponding storage unit. The process of the processing unit performing data preprocessing on the unit value by using the predetermined algorithm and transmitting the processed data to the receiving portion may be performed by:

receiving, by the calculation module, the unit value transmitted by the corresponding sensing unit, perform calculation by the calculation module based on the unit value to generate preprocessing data, and transmitting, by the calculation module, the preprocessing data to the corresponding storage unit, where calculation modules in the same calculation unit perform calculation by using different algorithms; and

storing, by the storage unit, the corresponding preprocessing data, and transmitting, by the storage unit, the preprocessing data to the receiving portion.

Optionally, the processing unit includes a control unit and multiple calculation units, the sensing units are respectively connected with the calculation units in a one-to-one correspondence, the calculation units are connected with the control unit, and the control unit is connected with the sensing units. The process of the processing unit performing data preprocessing on the unit value by using the predetermined algorithm and controlling the sensing unit to transmit the unit value to the receiving portion in the case that the processing result meets the predetermined condition may be performed by:

receiving an external signal convert the external signal into a unit value by the sensing unit, and transmitting, by the sensing unit, the unit value to the corresponding calculation unit;

receiving, by the calculation unit, the unit value transmitted by the corresponding sensing unit, processing the unit value by the calculation unit by using the predetermined algorithm, and transmitting, by the calculation unit, the processed data to the control unit; and

controlling, by the control unit, the corresponding sensing unit to transmit the unit value to the receiving portion in the case that the processed data meets the predetermined condition.

Optionally, the predetermined algorithm includes at least one of a numerical operation, a logical operation or a sorting operation.

Optionally, as shown in FIG. 13, the method may further include the following steps S21 to S23.

In S21, the processing unit acquires data feature quantities of the sensing units respectively calculated by the processing modules.

In S22, the processing unit screens out an eligible sensing unit according to a preset noise feature quantity and the data feature quantities respectively corresponding to the sensing units.

In S23, the processing unit controls the eligible sensing unit to transmit data to the data receiving portion.

The data feature quantity of the corresponding sensing unit calculated by the processing module may be calculated by the processing module according to a predetermined algorithm and based on data (which may also be expressed as a unit value herein and does not represent a different meaning) transmitted by the corresponding sensing unit. The data feature quantity may be a value corresponding to the preset noise feature quantity, or the like, so that the processing unit performs calculation according to the preset noise feature quantity and the data feature quantity to screen each sensing unit. For example, the data feature quantity may be a variance or a fourth-order moment of the data (signal) transmitted by the sensing unit, or the like.

In practical applications, as a module for converting an external signal into an electrical signal in the array sensor, the sensing unit generally includes a conversion module configured to convert the external signal into the electrical signal. Further, the sensing unit may be configured according to the actual type and the function of the array sensor. The array sensor may be a piezoresistive, piezoelectric, photoelectric, capacitive or electromagnetic sensor. In this case, the conversion module of the sensing unit may be configured as, for example, a photosensitive element to convert a light signal into an electrical signal and output the electrical signal. For another example, the conversion module of the sensing unit may be configured as a sound sensing element to convert a sound signal into an electrical signal and output the electrical signal. Therefore, the specific selection and configuration of the sensing unit is not limited in the embodiments of the present disclosure, as long as the sensing unit can convert the external signal into an electrical signal.

It should be noted that, with respect to the process of the processing unit screening out the eligible sensing unit according to the preset noise feature quantity and the data feature quantities respectively corresponding to the sensing units, the preset noise feature quantity may be a feature quantity that is set for an electrical signal converted by each sensing unit and that is used for perform screening on the sensing unit according to a noise feature of the electrical signal. Correspondingly, whether the sensing unit transmits data to the data receiver may be determined by comparing the preset noise feature quantity with the data feature quantity corresponding to the array unit, so as to perform screening on the sensing units. Further, a signal-to-noise ratio of each sensing unit may be calculated according to the preset noise feature quantity and the data feature quantity corresponding to the sensing unit, and the sensing unit whose signal-to-noise ratio meets a condition is screened out according to the calibrated signal-to-noise ratio and is controlled to output data to the data receiving portion.

The data processing method provided in the embodiment of the present disclosure msu be applied to an array sensor. The array sensor may include a processing unit and multiple sensing units respectively having processing modules. The processing modules of the sensing units are all communicationally connected with the processing unit. In the method, firstly, the processing unit acquires the data feature quantity of the corresponding sensing unit calculated by each processing module, that is, the processing unit acquires the data feature quantity calculated by the processing module corresponding to each sensing unit. Next, the processing unit performs screening according to the data feature quantity corresponding to each sensing unit acquired by the processing unit and the preset noise feature quantity to screen out an eligible sensing unit, and controls the eligible sensing unit to transmit data to the data receiving portion. In this way, the data transmitted by the array sensor to the data receiving portion is from some of the sensing units, instead of all the sensing units transmitting data to the data receiving portion, so that the amount of data received and processed by the data receiving portion at the same time is reduced. Further, the receiving pressure when the data receiving portion receives the data of the array sensor and the calculation pressure for subsequent calculation and processing of the data are reduced, so as to improve the response speed of the data receiving portion.

Optionally, the preset noise feature quantity is any one of a preset fixed value, a data feature quantity meeting the predetermined condition, and a noise feature quantity obtained by sampling for a stationary object.

The preset fixed value may be a fixed noise value set by those skilled in the art according to previous experience of using the array sensor, so that the processing unit can calculate the signal-to-noise ratio of the sensing unit according to the fixed value and the acquired data feature quantity corresponding to the sensing unit and screen out the sensing unit with less electrical signal noise according to the signal-to-noise ratio, and thus the processing unit can only control the sensing unit (the eligible sensing unit) with less electrical signal noise to transmit the electrical signal (data) to the data receiving portion, thereby reducing the data receiving pressure of the data receiving portion and improving the quality (having less noise interference) of the data received by the data receiving portion. Further, in the embodiments of the present disclosure, the preset fixed value may be a fixed noise value calibrated when the array sensor is powered on, so that the processing unit can screen out the sensing unit with less electrical signal noise according to the fixed value and the data feature quantities of the sensing units, and thus the processing unit can only control the sensing unit (the eligible sensing unit) with less electrical signal noise to transmit the electrical signal (data) to the data receiving portion, thereby reducing the data receiving pressure of the data receiving portion and improving the quality (having less noise interference) of the data received by the data receiving portion. The specific determination method of the preset fixed value as the preset noise feature quantity is not limited in the embodiments of the present disclosure, as long as the preset fixed value can be used for screening out the eligible sensing unit.

It should be noted that, in the case that the array sensor is a photoelectric sensor and is used for optical ranging or other purposes, the noise feature quantity obtained by the sampling for the stationary object may be an echo energy (which may be regarded as the electrical signal or data converted by the sensing unit without receiving a useful signal, i.e., a noise energy) corresponding to the maximum measurement distance that is obtained based on the sampling data for the stationary object according to a specific conversion algorithm. Correspondingly, the data feature quantity of the sensing unit that is calculated by the corresponding processing module and acquired by the processing unit is the energy of the electrical signal into which an echo is converted by the corresponding sensing unit in ranging, so that the processing unit can perform screening the sensing unit based on the noise feature quantity (the echo energy corresponding to the maximum measurement distance) that is obtained by the sampling for the stationary object and the data feature quantity corresponding to each sensing unit (the energy of the electrical signal converted by the sensing unit), to control the eligible sensing unit to transmit the data to the data receiving portion, and thus a part of the array units whose electrical signal contains more noise do not transmit data to the data receiver, thereby reducing the data receiving pressure of the data receiving portion.

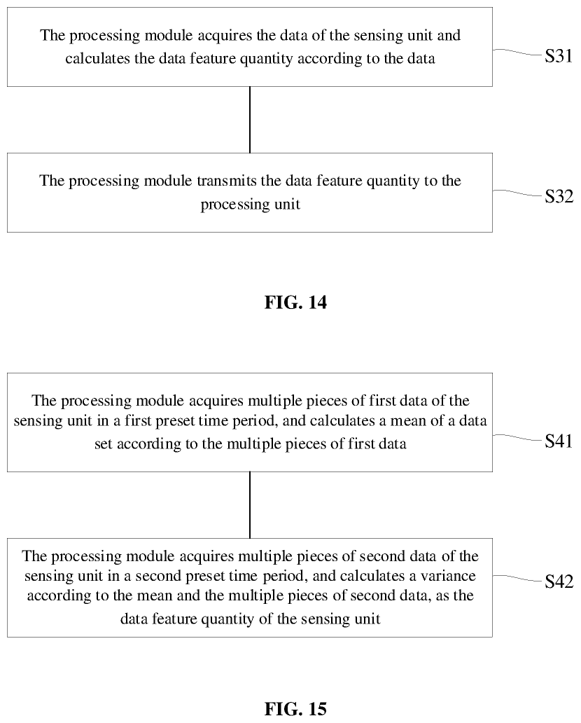

Optionally, as shown in FIG. 14, the process of the processing unit acquiring the data feature quantities of the sensing units respectively calculated by the processing modules may be performed by performing the following steps S31 and S32.

In S31, the processing module acquires the data of the sensing unit and calculates the data feature quantity according to the data.

In S32, the processing module transmits the data feature quantity to the processing unit.

The data feature quantity acquired by the processing unit may be calculated by the processing module of each sensing unit based on the electrical signal data transmitted by the sensing unit according to a predetermined algorithm.

The algorithm used by the processing module to perform calculation on the data of the corresponding sensing unit may be set according to the condition of the processing unit screening the eligible sensing unit and the preset noise feature quantity. For example, in the case that the preset noise feature quantity is a preset fixed value, the algorithm used by the processing module to calculate the data of the sensing unit may be set so that the processing module can obtain a value based on which and the preset fixed value the signal-to-noise ratio is calculated. The specific algorithm for the processing module to calculate the data feature quantity according to the data of the sensing unit is not limited in the embodiments of the present disclosure, as long as the processing module can obtain a numerical quantity (data feature quantity) that can be used by the processing unit to perform screening on the sensing unit.

By the processing module acquiring the data of the corresponding sensing unit and calculating the data feature quantity, the processing unit can more conveniently obtain the data feature quantity for performing screening on the sensing unit.

Optionally, as shown in FIG. 15, the process of the processing module acquiring data of the array unit and calculating the data feature quantity according to the data may be performed by performing the following steps S41 and S42.

In S41, the processing module acquires multiple pieces of first data of the sensing unit in a first preset time period, and calculates a mean of a data set according to the multiple pieces of first data.

In S42, the processing module acquires multiple pieces of second data of the sensing unit in a second preset time period, and calculates a variance according to the mean and the multiple pieces of second data, as the data feature quantity of the sensing unit.

It should be noted that, the variance of the data transmitted by each sensing unit may include a variance of a useful signal, a variance of an ambient noise, and a variance of the part whose noise energy is related to the signal energy in the noise. Further, according to the decoherence analysis, in the case that the distance between the sensing unit and the external signal source is given without considering the noise, the strength of a data signal converted by the sensing unit is reduced in a direction from a center of the sensing unit to an edge receiving position of the sensing unit. Therefore, the calculated minimum variance of the data signal transmitted by the sensing unit may be considered as the variance of an electrical signal converted from the external signal received at the edge of the sensing unit, and is equivalent to the signal variance when the useful signal is the smallest, i.e., the noise variance (which may function as the preset noise feature quantity) of the data transmitted by the sensing unit. Based on this, the variance of the data corresponding to each sensing unit is obtained by the above steps, as the data feature quantity, so that the processing unit can obtain the signal-to-noise ratio of the corresponding sensing unit based on the variance (the data feature quantity corresponding to the sensing unit) and the minimum variance (that is, the preset noise feature quantity), and thus can screen out the sensing unit with less data (signal) noise according to the signal-to-noise ratio, so as to control the screened sensing unit to transmit data to the data receiving portion.

Exemplarily, the process of the processing module acquiring the multiple pieces of first data of the sensing unit in the first preset time period and calculating the mean of the data set according to the multiple pieces of first data may be performed by:

acquiring by the processing module, the multiple pieces of first data of the sensing unit according to a sequence with a first preset sampling rate in the first preset time period and calculating an accumulated value by the processing module;

calculating by the processing module according to a duration of the first preset time period and the first preset sampling rate, the number of the pieces of first data acquired in the first preset time period; and

calculating the mean by the processing module according to the accumulated value and the number of the pieces of first data.

That is, the data transmitted by the sensing unit is accumulated one by one according to the sampling order, and the mean of the sampled data is calculated according to the number of samples that is obtained based on the sampling rate and the sampling time, which is calculated according to the following formula.

X=X+x(t)

In this case, the mean is obtained, i.e., a=X/m₁.

In the above formula, x(t) represents the first data acquired at each sampling time instant according to the sampling rate, and m1 represents the number of pieces of sampled data.

Exemplarily, the process of the processing module acquiring the multiple pieces of second data of the sensing unit in the second preset time period and calculating the variance according to the mean and the multiple pieces of second data may be performed by:

acquiring by the processing module, multiple pieces of second data of the sensing unit according to a sequence with a second preset sampling rate in the second preset time period;

calculating an accumulated difference squared value by the processing module according to the pieces of second data acquired in the second preset time period and the mean;

calculating by the processing module according to a duration of the second preset time period and the second preset sampling rate, the number of the pieces of second data acquired in the second preset time period; and

calculating the variance by the processing module according to the accumulated difference squared value and the number of the pieces of second data.

That is, the processing module subtracts the data of the sensing unit acquired at each sampling time instant from the mean obtained by the above calculation and calculates a squared value of a value obtained by the subtraction, and accumulates the calculated value for each acquired data, and calculates the variance (this variance may be regarded as the variance of the data transmitted from the corresponding array unit) according to the number of samples that is obtained based on the sampling rate and the sampling time, which is calculated according to the following formula.

Y=Y+(y(t)−a)\hat{ }2

In this case, the variance is obtained, i.e., σ=Y/m₂.

In the above formula, y(t) represents the second data acquired at each sampling time instant according to the sampling rate, a represents the mean of the first data, and m₂ represents the number of pieces of sampled data.

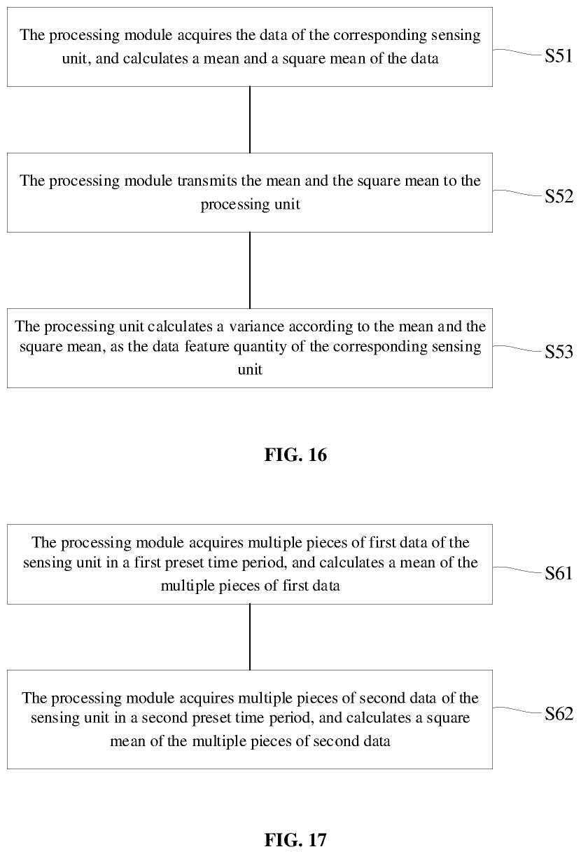

Optionally, as shown in FIG. 16, the process of the processing unit acquiring the data feature quantities of the sensing units respectively calculated by the processing modules may be performed by performing the following steps SM to S53.

In S51, the processing module acquires the data of the corresponding sensing unit, and calculates a mean and a square mean of the data.

In S52, the processing module transmits the mean and the square mean to the processing unit.

In S53, the processing unit calculates a variance according to the mean and the square mean, as the data feature quantity of the corresponding sensing unit.

It should be noted that the square mean is the mean of a set of a square of the acquired data.

The variance of the data transmitted by each sensing unit may include a variance of a useful signal, a variance of an ambient noise, and a variance of the part whose noise energy is related to the signal energy in the noise. Further, according to the decoherence analysis, in the case that the distance between the sensing unit and the external signal source is given without considering the noise, the strength of a data signal converted by the sensing unit is reduced in a direction from a center of the sensing unit to an edge receiving position of the sensing unit. Therefore, the calculated minimum variance of the data signal transmitted by the sensing unit may be considered as the variance of an electrical signal converted from the external signal received at the edge of the sensing unit, and is equivalent to the signal variance when the useful signal is the smallest, i.e., the noise variance (which may function as the preset noise feature quantity) of the data transmitted by the sensing unit. Based on this, this variance is used as the data feature quantity acquired by the processing unit, so that the processing unit can obtain the signal-to-noise ratio of the corresponding sensing unit based on the variance and the calculated minimum variance, and thus can screen out the sensing unit with less data (signal) noise according to the signal-to-noise ratio, so as to control the screened sensing unit to transmit data to the data receiving portion.

By performing the above steps, the data of the sensing unit is acquired by the corresponding processing module, and the mean and the square mean of the acquired data are calculated and transmitted to the processing unit, so that the processing unit can calculate the variance of the data transmitted by the sensing unit according to the received mean and square mean, as the data feature quantity (that is, the data feature quantity of the corresponding sensing unit calculated by the processing module is obtained). In this way, the calculation processing in the processing module can be simplified in the process of obtaining the data feature quantity by the processing unit, so that the structure (circuit complexity, etc.) of the processing module can be simplified, and the processing module can have a relatively small size, so as to be conveniently arranged in a small-sized array unit.

Optionally, as shown in FIG. 17, the process of the processing module acquiring the data of the corresponding sensing unit and calculating the mean and the square mean of the data may be performed by performing the following steps S61 and S62.

In S61, the processing module acquires multiple pieces of first data of the sensing unit in a first preset time period, and calculates a mean of the multiple pieces of first data.

In S62, the processing module acquires multiple pieces of second data of the sensing unit in a second preset time period, and calculates a square mean of the multiple pieces of second data.

By the above steps, the processing module acquires the data of the corresponding sensing unit and calculates the mean and the square mean, which can reduce the amount of the acquired data that is required to be stored by the processing module and the amount of data used for calculating the intermediate value, thereby further simplifying the structure of the processing module, which is beneficial to arrange the processing module in a relative small sensing unit.

Exemplarily, the process of the processing module acquiring the multiple pieces of first data of the sensing unit in the first preset time period and calculating the mean of the multiple pieces of first data may be performed by:

acquiring by the processing module, the multiple pieces of first data of the array unit according to a sequence with a first preset sampling rate in the first preset time period and calculating an accumulated value by the processing module;

calculating by the processing module according to a duration of the first preset time period and the first preset sampling rate, the number of the pieces of first data acquired in the first preset time period; and

calculating the mean by the processing module according to the accumulated value and the number of the pieces of first data.

That is, the data transmitted by the sensing unit is accumulated one by one according to the sampling order, and the mean of the sampled data is calculated according to the number of samples that is obtained based on the sampling rate and the sampling time, which is calculated according to the following formula.

X=X+x(t)

In this case, the mean is obtained, i.e., a=X/m₁.

In the above formula, x(t) represents the first data acquired at each sampling time instant according to the sampling rate, and m1 represents the number of pieces of sampled data.

Exemplarily, the process of the processing module acquiring the multiple pieces of second data of the sensing unit in the second preset time period and calculating the square mean of the multiple pieces of second data may be performed by:

acquiring by the processing module, multiple pieces of second data of the sensing unit according to a sequence with a second preset sampling rate in the second preset time period and calculating an accumulated squared value;

calculating by the processing module according to a duration of the second preset time period and the second preset sampling rate, the number of the pieces of second data acquired in the second preset time period; and

calculating the square mean by the processing module according to the accumulated squared value and the number of the pieces of second data.

That is, the processing module accumulates the squared value of the acquired data according to the sampling order, and obtains the number of samples according to the sampling rate and sampling time to calculate the mean of the squared value of the sampled data, thereby obtaining the square mean of the acquired second data, which is calculated according to the following formula.

Y=Y+y(t)\hat{ }2

In this case, the mean is obtained, i.e., b=Y/m₂.

In the above formula, y(t) represents the second data acquired at each sampling time instant according to the sampling rate, and m₂ represents the number of pieces of sampled data.

Correspondingly, the processing unit calculates the variance according to the mean and the square mean, which is calculated according to the following formula.

σ=(b−a\hat{ }2)^{1/2}

where σ represents the obtained variance, b represents the square mean of the second data, and a represents the mean of the first data.

Optionally, the preset noise feature quantity is a data feature quantity meeting the predetermined condition, and before the processing unit screens out the eligible sensing unit according to the preset noise feature quantity and the data feature quantities respectively corresponding to the sensing units, the method further includes:

selecting, by the processing unit, the minimum value among the data feature quantities as the preset noise feature quantity, or

acquiring, by the processing unit, a value located at a preset quantile fractile from a set consisting of the data feature quantities as the preset noise feature quantity.

The minimum value among the data feature quantities may the minimum value in the set consisting of the data feature quantities respectively corresponding to the sensing units.

The value located at the preset quantile fractile from the set consisting of the data feature quantities may be determined by the following process. In the set consisting of the data feature quantities respectively corresponding to the sensing units, all the data feature quantities are sorted in accordance with the order from small to large to obtain the value located at the preset quantile fractile. The preset quantile fractile may be represented by a quantile, that is, a percentage greater than 0 and less than 1. For example, if the preset quantile is 1%, a product (sequence number) of 1% and a cardinality of the corresponding set represents the position corresponding the preset quantile fractile. That is, an element in the set consisting of the data feature quantities, at a position corresponding to the sequence number after the sorting from small to large is determined as the value located at the preset quantile fractile.

By the above two ways, the preset noise feature quantity can be obtained by processing the data feature quantities respectively calculated for the sensing units. By means of the preset noise feature quantity derived from the data feature quantities respectively corresponding to the sensing units, real noise of the sensing unit can be more accurately reflected, so that the processing unit can more accurately obtain the signal-to-noise ratio of the sensing unit used for screening the sensing unit, which is time-efficient.

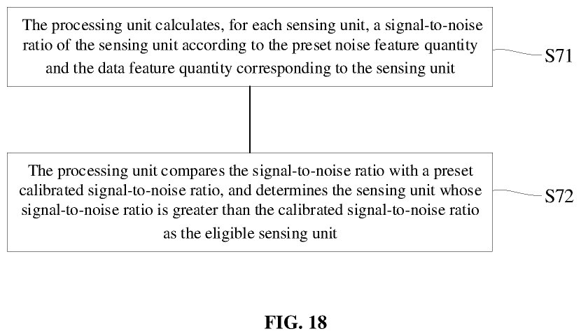

Exemplarily, as shown in FIG. 18, the process of the processing unit screening out the eligible sensing unit according to the preset noise feature quantity and the data feature quantities respectively corresponding to the sensing units is performed by performing the following steps S71 and S72.

In S71, the processing unit calculates, for each sensing unit, a signal-to-noise ratio of the sensing unit according to the preset noise feature quantity and the data feature quantity corresponding to the sensing unit.

In S72, the processing unit compares the signal-to-noise ratio with the preset calibrated signal-to-noise ratio, and determines the array unit whose signal-to-noise ratio is greater than the calibrated signal-to-noise ratio as the eligible sensing unit.

The preset calibrated signal-to-noise ratio includes a preset fixed value and/or a value located at a preset quantile fractile in a set consisting of the signal-to-noise ratios of the sensing units.

Exemplarily, the signal-to-noise ratio of the sensing unit may be calculated according to the following formula.

$$I ( n ) = 10 * 1 g \frac{σ ( n )}{\tilde{σ}}$$

where I(n) represents a signal-to-noise ratio of a n-th sensing unit, σ(n) represents a data feature quantity (such as the variance of the data) of the n-th sensing unit, and [symbol] represents the preset noise feature quantity (the minimum value among the variances of the data, or the value located at the preset quantile fractile, or the like).

It should be noted that, relational terms such as “first” and “second” herein are only used to distinguish one entity or operation from another entity or operation, and do not necessarily require or imply there is such actual relationship or sequence between these entities or operations. Moreover, terms “comprising”, “including” or any other variations thereof are intended to encompass a non-exclusive inclusion, such that a process, a method, an article or a device including a series of elements includes not only those elements, but also includes other elements that are not explicitly listed or inherent to such the process, method, article or device. Without further limitation, an element defined by a phrase “including a . . . ” does not preclude the presence of additional identical elements in a process, method, article or device including the element.

Preferred embodiments of the present disclosure are given in the above description, and are not intended to limit the present disclosure. For those skilled in the art, the present disclosure may have various modifications and changes. Any modifications, equivalents and improvements made in the spirit and principle of the present disclosure should be included in the protection scope of the present disclosure. It should be noted that similar numerals and letters refer to similar items in the following drawings. Therefore, if an item is defined in a drawing, the item is not required to be further defined and explained in subsequent drawings. Preferred embodiments of the present disclosure are given in the above description, and are not intended to limit the present disclosure. For those skilled in the art, the present disclosure may have various modifications and changes. Any modifications, equivalents and improvements made in the spirit and principle of the present disclosure should be included in the protection scope of the present disclosure.

1. An array sensor chip, comprising:
a processing unit; and
a plurality of sensing units, wherein
each of the plurality of sensing units is connected to the processing unit and is configured to: receive an external signal, convert the external signal into a unit value, and transmit the unit value to the processing unit according to a predetermined rule; and
the processing unit is configured to: perform data processing on the unit value by using a predetermined algorithm, and control the sensing unit to transmit the unit value to a receiving portion in a case that the processing result meets a predetermined condition or transmit the processed data to a receiving portion.

2. The array sensor chip according to claim 1, further comprising:
processing modules respectively connected to the sensing units, wherein
the processing unit is configured to: acquire data feature quantities of the plurality of sensing units respectively calculated by the processing modules; screen out an eligible array unit according to a preset noise feature quantity and the data feature quantities respectively corresponding to the plurality of sensing units; and control the eligible array unit to transmit the unit value to the receiving portion.

3. The array sensor chip according to claim 2, wherein the preset noise feature quantity is selected from one of a preset fixed value, the data feature quantity meeting the predetermined condition, and a noise feature quantity obtained by sampling for a stationary object.

4. The array sensor chip according to claim 2, wherein each of the processing modules is configured to:
acquire a plurality of pieces of first data of corresponding array unit in a first preset time period, and calculate a mean of a data set based on the plurality of pieces of first data;
acquire a plurality of pieces of second data of the array unit in a second preset time period, and calculate a variance based on the mean and the plurality of pieces of second data, as the data feature quantity of the array unit; and
transmit the data feature quantity to the processing unit.

5. The array sensor chip according to claim 2, wherein the preset noise feature quantity is the data feature quantity meeting the predetermined condition, and the processing unit is further configured to: select the minimum value among the data feature quantities as the preset noise feature quantity, or acquire a value located at a preset quantile fractile from a set consisting of the data feature quantities as the preset noise feature quantity.

6. The array sensor chip according to claim 2, wherein the processing unit is configured to:
acquire the data feature quantities of the array units respectively calculated by the processing modules;
calculate, for each of the array units, a signal-to-noise ratio of the array unit based on the preset noise feature quantity and the data feature quantity of the array unit; and
compare, for each of the array units, the signal-to-noise ratio of the array unit with a preset calibrated signal-to-noise ratio, and determine the array unit whose signal-to-noise ratio is greater than the preset calibrated signal-to-noise ratio as the eligible array unit; and
control the eligible array unit to transmit the unit value to the receiving portion; wherein
the preset calibrated signal-to-noise ratio comprises a preset fixed value and/or a value located at a preset quantile fractile in a set consisting of the signal-to-noise ratios of the array units.

7. The array sensor chip according to claim 1, wherein the predetermined rule comprises a predetermined adjustment rule for a connection relationship and/or a corresponding relationship between the sensing units and the processing unit.

8. The array sensor chip according to claim 1, wherein the processing unit comprises: a calculation unit and a storage unit, wherein
the calculation unit is configured to perform data processing on at least one of the received unit values of one or more of the sensing units and/or at least one stored value of the storage unit by using the predetermined algorithm; and
the storage unit is configured to store the at least one of the unit values of one or more of the sensing units, and/or at least one piece of data processed by one or more calculation units.

9. The array sensor chip according to claim 1, wherein the processing unit comprises a calculation unit and a storage unit that are connected to each other, and one or more of the sensing units are connected to the calculation unit, and wherein
the calculation unit is configured to: receive unit values respectively transmitted by the one or more of the sensing units, perform data processing based on the unit value and a storage value of the storage unit, and transmit the processed data to the storage unit; and
the storage unit is configured to transmit the processed data to the receiving portion.

10. The array sensor chip according to claim 1, wherein the processing unit comprises a calculation unit and a storage unit that are connected to each other, and the sensing units are connected to the storage unit, and wherein
the storage unit is configured to receive at least one of the unit values respectively transmitted by the sensing units; and
the calculation unit is configured to process the at least one of the unit values of the sensing units stored in the storage unit by using the predetermined algorithm, and transmit the processed unit value to the receiving portion.

11. The array sensor chip according to claim 1, wherein the processing unit comprises a plurality of processing submodules connected in sequence, and the sensing units are connected to the processing submodule located at the head end, and wherein
the processing submodules are configured to: sequentially perform calculation based on the unit value transmitted by each of the sensing units to generate preprocessing data, and transmit the preprocessing data to the receiving portion.

12. The array sensor chip according to claim 11, wherein each of the processing submodules comprises a calculation unit and a storage unit that are connected to each other, the calculation unit of one of adjacent processing submodules is connected to the storage unit of the other of the adjacent processing submodules, and the sensing units are connected to the calculation unit of the processing submodule located at the head end, and wherein
the calculation units of the processing submodules are configured to: sequentially perform calculation based on the corresponding unit value or data in the storage unit to generate preprocessing data, and transmit the preprocessing data to the receiving portion; and
the storage unit is configured to receive and store the data calculated by the corresponding calculation unit.

13. The array sensor chip according to claim 1, wherein the processing unit comprises a plurality of first calculation units, and the first calculation units are respectively connected to storage units, and each of the sensing units is connected to the first calculation units, and wherein
each of the first calculation units is configured to: receive the unit values respectively transmitted by the sensing units, process the unit value meeting a predetermined processing condition and/or the stored value of the corresponding storage unit, and transmit the processed data to the corresponding storage unit; and
each of the storage units is configured to store the corresponding processed data and transmit the processed data to the receiving portion.

14. The array sensor chip according to claim 1, wherein the processing unit comprises a plurality of first calculation units and a second calculation unit, and the first calculation units are respectively connected to storage units, each of the sensing units is connected to the first calculation units, and the storage units are connected to the second calculation unit, and wherein
each of the first calculation units is configured to: receive the unit values respectively transmitted by the sensing units, perform calculation based on the unit value meeting a predetermined processing condition and/or the stored value of the corresponding storage unit to generate intermediate data, and transmit the intermediate data to the corresponding storage unit;
each of the storage units is configured to store the corresponding intermediate data, and transmit the intermediate data to the second calculation unit; and
the second calculation unit is configured to perform calculation based on pieces of the intermediate data to generate preprocessing data, and transmit the preprocessing data to the receiving portion.

15. The array sensor chip according to claim 1, wherein the processing unit comprises a plurality of calculation units and a plurality of storage units, the calculation units are respectively connected to the sensing units in a one-to-one correspondence, and the calculation units are respectively connected to the storage units in a one-to-one correspondence, each of the calculation units comprises at least one calculation module, and the calculation module is connected to the corresponding sensing unit and the corresponding storage unit, and wherein
the calculation module is configured to: receive the unit value transmitted by the corresponding sensing unit, perform calculation based on the unit value to generate preprocessing data, and transmit the preprocessing data to the corresponding storage unit, wherein calculation modules in a same calculation unit perform calculation by using different algorithms; and
each of the storage units is configured to store the corresponding preprocessing data, and transmit the preprocessing data to the receiving portion.

16. The array sensor chip according to claim 1, wherein the processing unit comprises a control unit and a plurality of calculation units, the sensing units are respectively connected to the calculation units in a one-to-one correspondence, and the calculation units are connected to the control unit, and the control unit is connected to the sensing units, and wherein
each of the sensing units is configured to receive an external signal, convert the external signal into a unit value, and transmit the unit value to the corresponding calculation unit;
each of the calculation units is configured to receive the unit value transmitted by the corresponding sensing unit, process the unit value by using a predetermined algorithm, and transmit the processed data to the control unit; and
the control unit is configured to control the sensing unit to transmit the unit value to the receiving portion in a case that the processed data meets a predetermined condition.

17. The array sensor chip according to claim 1, wherein the predetermined algorithm comprises at least one of a numerical operation, a logical operation or a sorting operation.

18. The array sensor chip according to claim 8, wherein the sensing units, the calculation unit and the storage unit are arranged on at least one integrated circuit.

19. A data output method of an array sensor chip, wherein the array sensor chip comprises: a processing unit and a plurality of sensing units, and each of the plurality of the sensing units is connected to the processing unit, and wherein the method comprises:
receiving, by the processing unit, a unit value transmitted by each of the sensing units according to a predetermined rule, wherein the unit value is obtained by converting an external signal by the sensing unit;
performing, by the processing unit, data preprocessing on the unit value by using a predetermined algorithm; and
controlling the sensing unit to transmit the unit value to a receiving portion in a case that the processing result meets a predetermined condition or transmitting the processed data to a receiving portion.

20. The data output method of an array sensor chip according to claim 19, further comprising:
screening out, by the processing unit, an eligible array unit according to a preset noise feature quantity and data feature quantities of the plurality of sensing units; and
controlling, by the processing unit, the eligible sensing unit to transmit the unit value of the eligible sensing unit to the receiving portion.
